(19) United States
(12) Patent Application Publication
(10) Pub. No.: US 2024/0345681 A1
(43) Pub. Date: Oct. 17, 2024

(54) INFORMATION PROCESSING SYSTEM, INFORMATION PROCESSING METHOD, AND NON-TRANSITORY COMPUTER READABLE MEDIUM

(71) Applicant: FUJIFILM Business Innovation Corp., Tokyo (JP)

(72) Inventor: Kohshiro INOMATA, Yokohama-shi (JP)

(73) Assignee: FUJIFILM Business Innovation Corp., Tokyo (JP)

(21) Appl. No.: 18/492,571

(22) Filed: Oct. 23, 2023

(30) Foreign Application Priority Data
Apr. 14, 2023 (JP) 2023-066593

(51) Int. Cl. G06F 3/041; G06F 3/04842; G06F 3/0488

(52) U.S. Cl. CPC G06F 3/0418; G06F 3/04842; G06F 3/0488; G06F 3/044; G06F 2203/04101

(57) ABSTRACT

An information processing system includes a processor configured to accept a contact operation with a target for an object displayed on a screen in response to the target coming into contact with the screen; and accept a contactless operation with the target for the object in response to detection of the target at a position away from the screen, the contactless operation including movement of a detected position of the target in the screen.

### CROSS-REFERENCE TO RELATED APPLICATIONS

This application is based on and claims priority under 35 USC 119 from Japanese Patent Application No. 2023-066593 filed Apr. 14, 2023.

### BACKGROUND

### (i) Technical Field

The present disclosure relates to an information processing system, an information processing method, and a non-transitory computer readable medium.

### (ii) Related Art

Japanese Unexamined Patent Application Publication No. 2015-148960 discloses an information processing apparatus including position determination means for determining a position on a display surface of a display unit that displays information, the position on the display surface corresponding to the position of an operating object that is not in contact with the display surface and that is detected in a mid-air area close to the display surface; operation identification means for identifying an input operation based on a predetermined motion of the operating object detected in the mid-air area, and execution means for executing a predetermined process in accordance with the position determined by the position determination means and the input operation identified by the operation identification means.

### SUMMARY

One method for selecting an object in a screen in a contactless manner is to keep a target with which to perform a contactless operation hovering over the object for a predetermined amount of time or more. In such a contactless operation, the motion of the user to bring their finger (i.e., target) close to the screen for a contact operation may be determined to be a motion to keep the target with which to perform the contactless operation hovering over an object for a predetermined amount of time or more.

Aspects of non-limiting embodiments of the present disclosure relate to prevention or reduction of the occurrence of erroneous operations on an object until a target with which to perform a contactless operation comes into contact with a screen, as compared with a case where the contactless operation on the object is accepted by keeping the target hovering over the object for a predetermined amount of time or more.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor configured to accept a contact operation with a target for an object displayed on a screen in response to the target coming into contact with the screen; and accept a contactless operation with the target for the object in response to detection of the target at a position away from the screen, the contactless operation including movement of a detected position of the target in the screen.

### BRIEF DESCRIPTION OF THE DRAWINGS

An exemplary embodiment of the present disclosure will be described in detail based on the following figures, wherein:

FIG. 1 is a diagram illustrating an example configuration of an information processing system including a contactless user interface through which a user performs an operation in a contactless manner;

FIG. 2 is a perspective view of a substantial part of an image processing apparatus according to an exemplary embodiment;

FIG. 3A is a sectional view of an operation panel;

FIG. 3B is a plan view of the operation panel when viewed in a direction facing a display surface of the operation panel;

FIG. 4 is a diagram illustrating an example functional configuration of the image processing apparatus according to the exemplary embodiment;

FIG. 5 is a diagram illustrating an example transition of a screen displayed on the operation panel, presenting how the screen transitions in response to the user operating the operation panel;

FIG. 6 is a diagram illustrating an example in which the user selects a “Copy” button, which is an example object, on a home screen;

FIG. 7 is a block diagram illustrating an example configuration of a substantial part of an electrical system of the image processing apparatus according to the exemplary embodiment;

FIG. 8 is a front view of a print screen on the operation panel of the image processing apparatus as viewed from the front;

FIG. 9 is a front view of the print screen, illustrating a state in which the user's finger is moved to above an intended object;

FIG. 10 is a front view of the print screen, illustrating a state in which, in the state illustrated in FIG. 9, the user's finger is moved from above the intended object to the outside of the print screen;

FIG. 11 is a front view of the print screen, illustrating a state in which, in the state illustrated in FIG. 10, the user's finger moved to the outside of the print screen is returned to above the intended object;

FIG. 12 is a front view of the print screen, illustrating a state in which, in the state illustrated in FIG. 11, the next screen is displayed in response to an operation on the object selected by the user;

FIG. 13 is a front view of the print screen, illustrating a state in which, in the state illustrated in FIG. 10, the user's finger moved to the outside of the print screen is moved to above an object adjacent to the intended object;

FIG. 14 is an enlarged view of the print screen illustrated in FIG. 13;

FIG. 15 is a front view of the print screen, illustrating a state in which, in the state illustrated in FIG. 9, the user's finger is moved from above the intended object to a position away therefrom;

FIG. 16 is a front view of the print screen, illustrating a state in which a finger of the user's one hand is moved to above the intended object and a finger of the user's other hand is placed at a position away from the intended object;

FIG. 17 is a side view of the print screen corresponding to the view of FIG. 16, when the operation panel is viewed from a side, illustrating a state in which the finger of the user's one hand is closer to the print screen than the finger of the user's other hand;

FIG. 18 is side view of the print screen, illustrating a state in which, in the state illustrated in FIG. 17, the finger of the user's other hand is brought closer to the print screen than the finger of the user's one hand;

FIG. 19 is side view of the print screen, illustrating a state in which, in the state illustrated in FIG. 18, the finger of the user's other hand is brought farther away from the print screen than the finger of the user's one hand;

FIG. 20 is a side view of an operation panel arranged obliquely, as viewed from a side, illustrating a state in which the user's finger is in close proximity to a print screen on the operation panel;

FIG. 21 is a side view of the operation panel, illustrating a state in which, in the state illustrated in FIG. 20, another finger different from an already detected finger of the user is detected;

FIG. 22 is a side view of the operation panel, illustrating a state in which, in the state illustrated in FIG. 21, the initially detected finger of the user is detected again;

FIG. 23 is a front view of the operation panel illustrated in FIG. 22, with a lower area thereof defined as a detection invalid area;

FIG. 24 is a flowchart illustrating an example of a process flow for contact operation and contactless operation based on an information processing program according to an exemplary embodiment; and

FIG. 25 is a flowchart illustrating an example of a contactless temporary mode process in the flowchart illustrated in FIG. 24.

### DETAILED DESCRIPTION

The following describes an exemplary embodiment of the present disclosure in detail with reference to the drawings. Components and processes that have substantially the same operations and functions are assigned the same reference symbols throughout the drawings, and redundant descriptions thereof may be omitted. The drawings are merely presented in schematic form to allow a full understanding of the present disclosure. Therefore, the present disclosure is not limited to only the illustrated examples. In the present exemplary embodiment, descriptions of configurations that are not directly related to the present disclosure or are well known may be omitted.

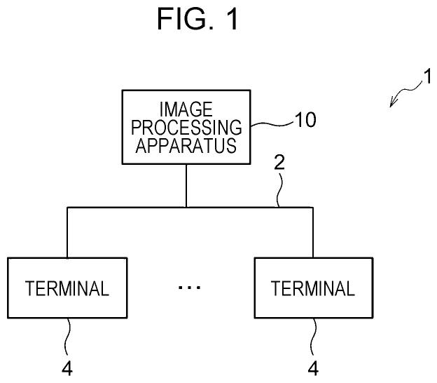

FIG. 1 is a diagram illustrating an example configuration of an information processing system 1 including an information processing apparatus having a contactless user interface through which a user performs an operation in a contactless manner.

The information processing apparatus in the information processing system 1 may be applied to any field as long as the information processing apparatus has a contactless user interface. Examples of the information processing apparatus include an image processing apparatus, an automatic teller machine (ATM), a vending machine, and an automatic ticket dispenser. The information processing apparatus may be for personal use only or usable by an unspecified number of users.

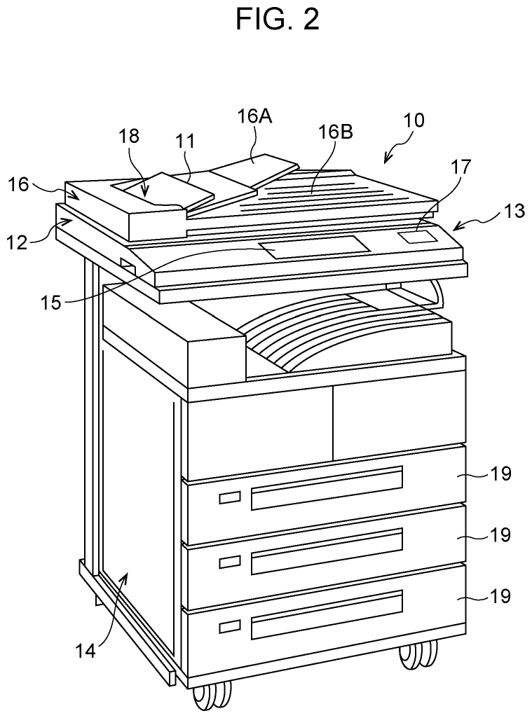

An image processing apparatus 10 installed in a workplace as an example of the information processing apparatus will be described hereinafter with reference to FIGS. 1 and 2.

FIG. 2 is a perspective view of a substantial part of the image processing apparatus 10 according to the present exemplary embodiment.

As described below, the image processing apparatus 10 is configured to execute functions related to images in accordance with instructions from users. The image processing apparatus 10 is connected to, for example, a plurality of terminals 4 to be used by individual users via a communication line 2.

Each user transmits image data generated by a corresponding one of the terminals 4 to the image processing apparatus 10 through the communication line 2 to cause the image processing apparatus 10 to execute desired image processing. Alternatively, a user may bring a portable storage medium such as a Universal Serial Bus (USB) memory or a memory card storing image data to the image processing apparatus 10 and connect the portable storage medium to the image processing apparatus 10 to cause the image processing apparatus 10 to execute desired image processing. Alternatively, a user may bring a document 11 having at least one of text or an image to the image processing apparatus 10 and make the image processing apparatus 10 read the document 11 to cause the image processing apparatus 10 to execute desired image processing.

The communication line 2 may be of any type that provides a connection between the image processing apparatus 10 and the terminals 4, such as a wired connection, a wireless connection, or a combination of wired and wireless connections. In addition, any number of terminals 4 may be connected to the image processing apparatus 10. For example, none of the terminals 4 may be connected to the image processing apparatus 10.

The terminals 4 are information devices configured to be used by users. The terminals 4 may be any type of information device having a data storage function and a data communication function. The terminals 4 include, for example, computers intended to be used at fixed positions, and mobile terminals intended to be transported and used, such as smartphones and wearable devices.

As illustrated in FIG. 2, the image processing apparatus 10 has, for example, a scan function for reading an image on a recording medium such as paper as image data, a print function for forming an image represented by image data on a recording medium, and a copy function for forming the same image as an image formed on a recording medium onto another recording medium. The copy function, the print function, and the scan function are examples of image processing to be performed by the image processing apparatus 10.

The image processing apparatus 10 illustrated in FIG. 2 includes, for example, a document reading device 12 in an upper portion thereof, and an image forming device 14 below the document reading device 12.

The document reading device 12 includes an optical reading device (not illustrated) and a document transport device 18. The document transport device 18 is disposed in a document cover 16. The document cover 16 is provided with a document table 16A, on which documents 11 are placed. The document transport device 18 sequentially feeds each of the documents 11 on the document table 16A and transports the document 11 onto a transported-document scanning glass (not illustrated). The document reading device 12 reads the content of the document 11 transported onto the transported-document scanning glass as image data using the optical reading device. Thereafter, the document transport device 18 discharges the document 11 whose content has been read onto a discharge table 16B included in the document cover 16.

The image forming device 14 forms an image represented by image data on a recording medium. Recording media are stored in storage trays 19 that are classified by the type or size of recording media. The image forming device 14 may form an image in any color on a recording medium and may form a color image or a monochrome image.

The image processing apparatus 10 includes, in a front portion thereof, an operation display device 13 that accepts an operation for executing various functions such as the copy function, the print function, and the scan function from a user.

Specifically, the operation display device 13 includes a reader device 17 that acquires information on a user who performs an operation, and an operation panel 15 that accepts an operation performed by the user.

For example, in response to the user bringing their employee identity card close to the reader device 17, the reader device 17 reads identification information (referred to as a “user ID”) for uniquely identifying the user from an integrated circuit (IC) chip incorporated in the employee identity card in a contactless manner.

The operation panel 15 is a display having a touch panel superimposed thereon. The operation panel 15 displays, as an icon image, an object to be operated by the user to execute a desired function. The object may be of any type that is to be operated by the user, and includes, for example, a button, a scroll bar, a check box, and a radio button. In response to the user performing an operation on the object, the image processing apparatus 10 executes a process associated in advance with the content of the operation, and a response to the operation is displayed on the operation panel 15.

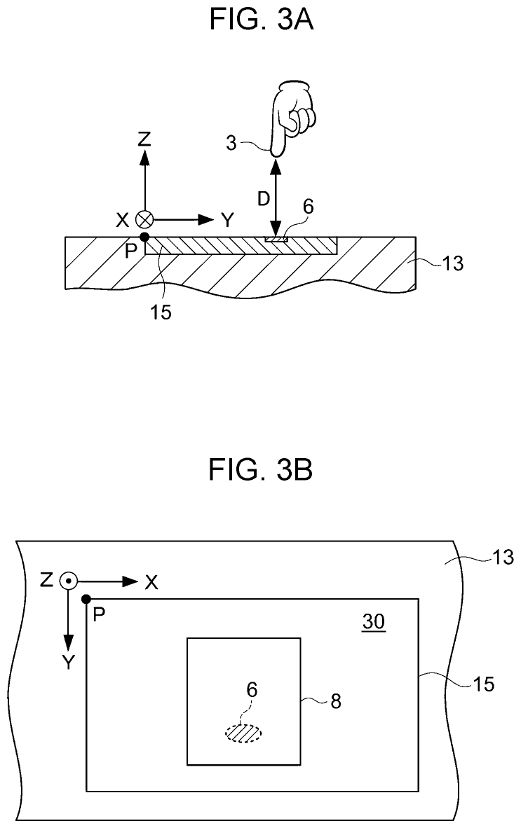

FIGS. 3A and 3B illustrate an example of the operation panel 15 that allows detection of an operation position 6 of the user in a contactless manner. FIG. 3A is a sectional view of the operation panel 15, and FIG. 3B is a plan view of the operation panel 15 when viewed in a direction facing a display surface of the operation panel 15.

The operation panel 15 detects the position of the user's finger, that is, the operation position 6, in a contactless manner. The expression “detecting the operation position 6 in a contactless manner” refers to detecting the position of a user's finger in response to the user holding their finger in a position in mid-air that is above a display surface of the operation panel 15 and that is away from the display surface of the operation panel 15 in a range of the display surface of the operation panel 15 without pressing their finger against the display surface of the operation panel 15. A mid-air space above the display surface of the operation panel 15 in a range of the display surface of the operation panel 15 is hereinafter referred to as a mid-air space “over the operation panel 15” or “above the operation panel 15”. The expression “holding the user's finger over something (such as the operation panel 15)” means that the user points at a position in mid-air over the operation panel 15 with their finger without touching the display surface of the operation panel 15.

The operation panel 15 includes a so-called capacitive touch panel that detects the operation position 6 from a change in electrostatic capacitance caused by the user holding their finger over the operation panel 15. In the operation panel 15 including such a touch panel, a change in electrostatic capacitance at a position closest to the user's finger is larger than a change in electrostatic capacitance at any other position. Accordingly, the operation panel 15 outputs, as the operation position 6 of the user, a position at which the change in electrostatic capacitance is largest within the range of the operation panel 15.

To identify the operation position 6 of the user on the operation panel 15, an operation coordinate system is defined for the operation panel 15 to define a detection area for contactless detection of the position of the user's finger. The operation coordinate system is represented as a three-dimensional coordinate system having any position on the operation panel 15 as an origin P. In the example of the operation panel 15 illustrated in FIGS. 3A and 3B, the origin P is set at one of the vertices of the outline of the rectangular operation panel 15. In the example of the operation panel 15 illustrated in FIGS. 3A and 3B, furthermore, an X axis is set along a lateral direction of the operation panel 15 with respect to the origin P, a Y axis is set along a longitudinal direction of the operation panel 15 with respect to the origin P, and a Z axis is set so as to be orthogonal to the X and Y axes. The Z-axis direction is referred to as a height direction of the operation panel 15.

The operation position 6 of the user on the operation panel 15 is represented by a coordinate point (x, y), which is a combination of the coordinate value x of the X coordinate and the coordinate value y of the Y coordinate of a position at which the change in electrostatic capacitance is largest within the range of the operation panel 15.

When the operation panel 15 displays objects, an object displayed so as to include the operation position 6 of the user is recognized as the object being operated by the user. In the example of the operation panel 15 illustrated in FIG. 3B, since the operation position 6 of the user is included in the area of a button 8 in a screen 30 displayed on the operation panel 15, the user is recognized as operating the button 8. An object displayed so as to include the operation position 6 of the user may be hereinafter referred to as an “object corresponding to the operation position 6”. The operation position 6 is an example of a “detected position at which an operation performed by a user has been detected” according to the present exemplary embodiment.

As illustrated in FIG. 3A, the length of a perpendicular drawn from a user's finger 3, which is held over the operation panel 15, to the display surface of the operation panel 15, that is, the distance from the user's finger 3 to the operation panel 15 in the height direction of the operation panel 15, is represented by an “operation distance D”. The user's finger 3 is an example of a target with which the user performs operations. The target may be a body part of the user, other than the user's hand or fingers, or may be a stylus or any other tool owned by the user. As the operation distance D decreases, the change in electrostatic capacitance at the operation position 6 of the user increases on the operation panel 15. Conversely, as the operation distance D increases, the change in electrostatic capacitance at the operation position 6 of the user decreases on the operation panel 15. Accordingly, associating the operation distance D with the amount of change in electrostatic capacitance in advance makes it possible to obtain the operation distance D from the amount of change in electrostatic capacitance on the operation panel 15.

Based on the correspondence relationship between the operation distance D and the amount of change in electrostatic capacitance, the operation panel 15 recognizes the operation position 6 of the user not only as a two-dimensional operation position 6 along the display surface of the operation panel 15 but also as a three-dimensional operation position 6 that takes the operation distance D into account. That is, when the operation position 6 of the user is represented as a three-dimensional position, the operation position 6 of the user is represented by a coordinate point (x, y, z) obtained by combining a coordinate value z representing the operation position 6 in the height direction of the operation panel 15 with the coordinate point (x, y). The coordinate value z is a coordinate value, on the Z axis, of a position the operation distance D away from the origin P along the Z axis.

The coordinate value z=0 means that the user is performing an operation while touching the display surface of the operation panel 15 with their finger. Accordingly, the image processing apparatus 10 also recognizes a difference in the manner of the operation of the user, such as whether the user is operating the operation panel 15 in a contactless manner or operating the operation panel 15 with their finger in contact with the operation panel 15. As described above, the operation panel 15 supports both a contact operation in which the user performs an operation while touching the display surface of the operation panel 15 with their finger and a contactless operation in which the user operates the operation panel 15 while holding their finger over the operation panel 15.

As described above, since the change in electrostatic capacitance at the operation position 6 of the user decreases on the operation panel 15 as the operation distance D increases, the operation distance D has an upper limit. If the user holds their finger over the operation panel 15 at a position exceeding the upper limit of the operation distance D, the electrostatic capacitance at the operation position 6 of the user does not change, and the operation panel 15 makes no response to the operation of the user.

The detection area for objects is an area in mid-air that is about 3 cm away from the operation panel 15, for example. In other words, in response to the user moving the user's finger 3 close to a position about 3 cm from the operation panel 15, the electrostatic capacitance in the corresponding object changes and a contactless input is detected. The XYZ coordinates of the position in the detection area of the user's finger 3 are acquired as those of the operation position 6. In response to the user further moving the user's finger 3 to a position closer than 3 cm, the XYZ coordinates of the position are acquired.

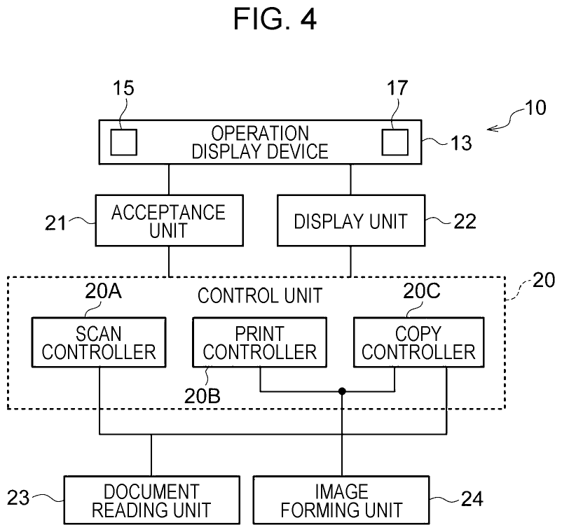

FIG. 4 is a diagram illustrating an example functional configuration of the image processing apparatus 10 according to the present exemplary embodiment. The image processing apparatus 10 includes functional units, namely, a control unit 20, an acceptance unit 21, a display unit 22, a document reading unit 23, and an image forming unit 24.

The acceptance unit 21 accepts a user ID of a user who operates the image processing apparatus 10 from the reader device 17 of the operation display device 13, and also accepts the operation position 6 of the user on the operation panel 15 from the operation panel 15 of the operation display device 13. The acceptance unit 21 further accepts image data from a portable storage medium connected to the terminal 4 of the user or the image processing apparatus 10. The acceptance unit 21 notifies the control unit 20 of the user ID, the operation position 6 of the user, and the image data, which have been accepted.

When notified of the user ID by the acceptance unit 21, the control unit 20 performs an authentication process to determine whether the user represented by the user ID is a user (referred to as a “registered user”) permitted to use the image processing apparatus 10. When notified of the operation position 6 of the user on the operation panel 15 by the acceptance unit 21, the control unit 20 determines whether the object displayed at the operation position 6 of the user is selected in the screen 30 displayed on the operation panel 15, and executes a process associated in advance with the selected object. For example, if the object is a button 8 for starting the print function, the control unit 20 starts the print function to form an image represented by the image data accepted by the acceptance unit 21 on a recording medium.

Since the image processing apparatus 10 has the copy function, the print function, and the scan function, the control unit 20 includes a scan controller 20A that controls the scan function, a print controller 20B that controls the print function, and a copy controller 20C that controls the copy function. Any one of the scan controller 20A, the print controller 20B, and the copy controller 20C performs control in accordance with the content of the process associated with the object operated by the user. In one example, the image processing apparatus 10 may have a facsimile function. In this example, the control unit 20 includes a facsimile controller that controls the facsimile function.

When the operation performed by the user through the object is an operation related to the scan function, the scan controller 20A controls the document reading unit 23 to implement the scan function. When the operation performed by the user through the object is an operation related to the print function, the print controller 20B controls the image forming unit 24 to implement the print function. When the operation performed by the user through the object is an operation related to the copy function, the copy controller 20C controls the document reading unit 23 to generate image data of the document 11. Thereafter, the copy controller 20C controls the image forming unit 24 to form an image represented by the generated image data on a recording medium.

The document reading unit 23 drives the document reading device 12 under the control of the scan controller 20A and the copy controller 20C to, for example, transport each of the documents 11 placed on the document table 16A and generate image data of the transported document 11.

The image forming unit 24 drives the image forming device 14 under the control of the print controller 20B and the copy controller 20C to, for example, transport a recording medium stored in any of the storage trays 19 and form an image represented by the image data on the transported recording medium.

The display unit 22 displays, for example, a result of the authentication process performed on the user and a result of the process executed by the control unit 20 in response to the operation performed by the user through the object on the operation panel 15 in the operation display device 13 in accordance with an instruction from the control unit 20.

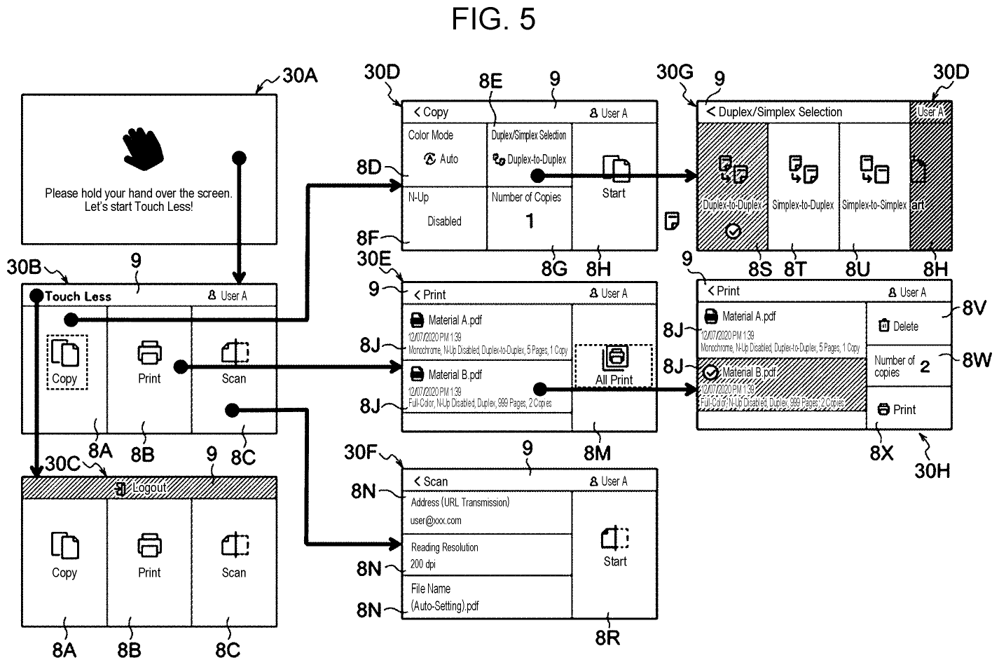

FIG. 5 is a diagram illustrating an example transition of the screen 30 displayed on the operation panel 15, presenting how the screen 30 transitions in response to the user operating the operation panel 15.

The display of the screen 30 on the operation panel 15, which is performed by the display unit 22, may also be interpreted as the display of the screen 30 on the operation panel 15 under the control unit 20 because the display unit 22 displays the screen 30 in accordance with an instruction from the control unit 20. A mid-air space extending along the Z axis and having a bottom surface corresponding to the display range of the screen 30 displayed on the operation panel 15 is expressed as a mid-air space “over the screen 30” or “above the screen 30”, and a mid-air space extending along the Z axis and having a bottom surface corresponding to the display range of an object displayed in the screen 30 is expressed as a mid-air space “over the object” or “above the object”. Like the expression “over the operation panel 15” or “above the operation panel 15”, the expression “over the screen 30” or “above the screen 30” and the expression “over the object” or “above the object” do not mean the upper side of the screen 30 and the upper side of the object based on the up, down, left, and right directions in the real space, respectively, but mean a mid-air space in a direction facing the screen 30 and a mid-air space in a direction facing the object, respectively.

For convenience of description, screens 30 whose types are distinguished from each other are accompanied by different alphabet symbols associated with the types of the screens 30. Screens 30 whose types are not distinguished from each other are collectively expressed as the “screens 30” regardless of their types. Buttons 8, which are example objects, whose types are distinguished from each other are accompanied by different alphabet symbols associated with the types of the buttons 8. Buttons 8 whose types are not distinguished from each other are collectively expressed as the “buttons 8” regardless of their types.

When it is determined that the user who performs an operation is a registered user through the authentication process, the control unit 20 causes a start screen 30A to be displayed on the operation panel 15. The start screen 30A displays an instruction given to the user, such as “Please hold your hand over the screen” and “Let's start Touch Less!”, for example.

When the user holds their finger over the start screen 30A, a cursor is displayed at the operation position 6 of the user on the start screen 30A. In the example of the start screen 30A illustrated in FIG. 5, a cursor in the shape of a hand is displayed. The shape of the cursor is an example, and, for example, a circular cursor may be displayed. In response to the user holding their finger over the start screen 30A, a home screen 30B is displayed. The instruction given to the user in the start screen 30A is also used to instruct the user how to perform an operation on the operation panel 15.

The home screen 30B displays, for example, buttons 8 for individually selecting the various functions of the image processing apparatus 10, and a navigation bar 9 for displaying information useful for the user to perform an operation. Since the image processing apparatus 10 has the copy function, the print function, and the scan function, a “Copy” button 8A for selecting the copy function, a “Print” button 8B for selecting the print function, and a “Scan” button 8C for selecting the scan function are displayed on the home screen 30B. The navigation bar 9 displays, for example, the name of a user who has been authenticated, such as “user A”, the name of a screen being displayed on the operation panel 15, such as “home”, and information for notifying the user that the operation panel 15 is in a contactless operation mode, such as “Touch Less”.

When the user holds their finger over the “Copy” button 8A and performs a predetermined selection operation, the “Copy” button 8A is selected. Upon selection of the “Copy” button 8A, a copy screen 30D is displayed on the operation panel 15. The copy screen 30D displays buttons 8D to 8G for setting copy conditions, and a copy start button 8H for starting copying under the set copy conditions. The selection operation performed by the user to select an object will be described in detail below.

The copy screen 30D illustrated in FIG. 5 displays, as an example of the buttons 8 for setting copy conditions, for example, a color mode button 8D for selecting a copy color, a duplex/simplex selection button 8E for selecting a double-sided (duplex) or single-sided (simplex) copy mode, an N-up button 8F for selecting an image layout on a recording medium, and a number-of-copies button 8G for selecting the number of copies to be made.

When the user holds their finger over any one of the buttons 8D to 8G for setting the respective copy conditions and performs a selection operation, the button 8 corresponding to the operation position 6 of the user is selected, and the screen 30 for setting the copy condition corresponding to the selected button 8 is displayed. In response to the duplex/simplex selection button 8E being selected on the copy screen 30D, a duplex/simplex selection screen 30G for selecting a duplex or simplex copy mode is displayed on the operation panel 15 in such a manner as to be superimposed on the copy screen 30D.

The duplex/simplex selection screen 30G illustrated in FIG. 5 displays, for example, a duplex-to-duplex selection button 8S for sequentially copying two-sided documents 11 on both sides of recording media, a simplex-to-duplex selection button 8T for sequentially copying one-sided documents 11 having text and the like on either side thereof on both sides of recording media, and a simplex-to-simplex selection button 8U for sequentially copying one-sided documents 11 having text and the like on either side thereof on either side of recording media.

When the user holds their finger over any one of the buttons 8S to 8U on the duplex/simplex selection screen 30G and performs a selection operation, the button 8 corresponding to the operation position 6 of the user is selected, and a copy mode corresponding to the selected button 8 is set. In the example of the duplex/simplex selection screen 30G illustrated in FIG. 5, the duplex-to-duplex selection button 8S is selected by the user.

In response to a duplex or simplex copy mode being set on the duplex/simplex selection screen 30G, the copy screen 30D is displayed on the operation panel 15. After the setting of the copy mode, the copy mode selected on the duplex/simplex selection screen 30G is displayed in the duplex/simplex selection button 8E on the copy screen 30D.

In the example described above, the user selects the duplex/simplex selection button 8E on the copy screen 30D. Also in response to the user selecting any one of the color mode button 8D, the N-up button 8F, and the number-of-copies button 8G on the copy screen 30D, a selection screen for selecting a copy condition corresponding to the selected one of the buttons 8 is displayed on the operation panel 15 in a manner similar to that for the duplex/simplex selection screen 30G.

When the user holds their finger over the copy start button 8H on the copy screen 30D and performs a selection operation, the copy start button 8H is selected. Upon selection of the copy start button 8H, a copying process for copying the content of the documents 11 on recording media is executed in accordance with the set copy conditions. Before the setting of the copy conditions, the buttons 8D to 8G on the copy screen 30D display initially set copy conditions that are set in advance.

When the user holds their finger over the “Print” button 8B on the home screen 30B and performs a selection operation, the “Print” button 8B is selected. Upon selection of the “Print” button 8B, a print screen 30E is displayed on the operation panel 15.

The print screen 30E displays print information buttons 8J each for displaying information on a piece of image data to be used for printing, and an all-print start button 8M for starting printing of all of the pieces of image data corresponding to the respective print information buttons 8J. In the example of the print screen 30E illustrated in FIG. 5, the print screen 30E in which two pieces of image data to be used for printing are accepted is illustrated. That is, the print screen 30E displays a number of print information buttons 8J equal to the number of pieces of image data accepted as targets for printing from the user, each print information button 8J corresponding to a corresponding one of the pieces of image data.

If the number of pieces of image data is too large to display the corresponding print information buttons 8J in the print screen 30E at the same time, in response to the user performing a gesture of moving their finger in an upward/downward direction of the print information buttons 8J, the operation panel 15 detects the movement of the operation position 6 and scrolls the print information buttons 8J. As a result, the print information buttons 8J that are not displayed in the print screen 30E are displayed in the print screen 30E.

Each of the print information buttons 8J displays a file name of image data to be used for printing and print conditions set by the user in advance for the image data. For example, when the user transmits image data from the terminal 4 to the image processing apparatus 10, print conditions set by the user using the terminal 4 are displayed in the print information button 8J.

When the user holds their finger over the all-print start button 8M and performs a selection operation, the all-print start button 8M is selected. Upon selection of the all-print start button 8M, a printing process for printing images represented by image data on recording media is executed in accordance with the set print conditions.

When the user holds their finger over any one of the print information buttons 8J and performs a selection operation, the print information button 8J is selected. Upon selection of any one of the print information buttons 8J, a print edit screen 30H is displayed on the operation panel 15. The print edit screen 30H illustrated in FIG. 5 is displayed, for example, in response to the user selecting the print information button 8J corresponding to the image data representing “Material B.pdf”.

The print edit screen 30H displays, for example, a delete button 8V for deleting the image data corresponding to the selected print information button 8J, a change button 8W for changing a print condition of the image data corresponding to the selected print information button 8J, and an individual-print start button 8X for printing only the image data corresponding to the selected print information button 8J. The print edit screen 30H illustrated in FIG. 5 displays, as an example of the change button 8W, a change button 8W for changing the number of copies to be printed. The print edit screen 30H also displays, for example, a change button 8W (not illustrated) for changing any other print condition, such as the color of an image to be printed.

When the user holds their finger over the “Scan” button 8C on the home screen 30B and performs a selection operation, the “Scan” button 8C is selected. Upon selection of the “Scan” button 8C, a scan screen 30F is displayed on the operation panel 15.

The scan screen 30F displays scan setting buttons 8N for setting scan conditions, and a scan start button 8R for starting reading of the documents 11 in accordance with the set scan conditions.

When the user holds their finger over any one of the scan setting buttons 8N and performs a selection operation, the scan setting button 8N corresponding to the operation position 6 of the user is selected, and a selection screen (not illustrated) for selecting the scan condition corresponding to the selected scan setting button 8N is displayed. That is, the user sets each of the scan conditions associated with the scan setting buttons 8N in the same manner as the operation of setting the copy conditions through the copy screen 30D. When the user holds their finger over the scan start button 8R and performs a selection operation, the scan start button 8R is selected. Upon selection of the scan start button 8R, a scanning process for converting the content of the documents 11 into image data is executed in accordance with the set scan conditions.

When the user holds their finger over the navigation bar 9 on the home screen 30B and performs a selection operation, the navigation bar 9 is selected. Upon selection of the navigation bar 9, a logout process of the authenticated user is performed. Then, as illustrated in a screen 30C, the navigation bar 9 displays an indication of completion of the logout process.

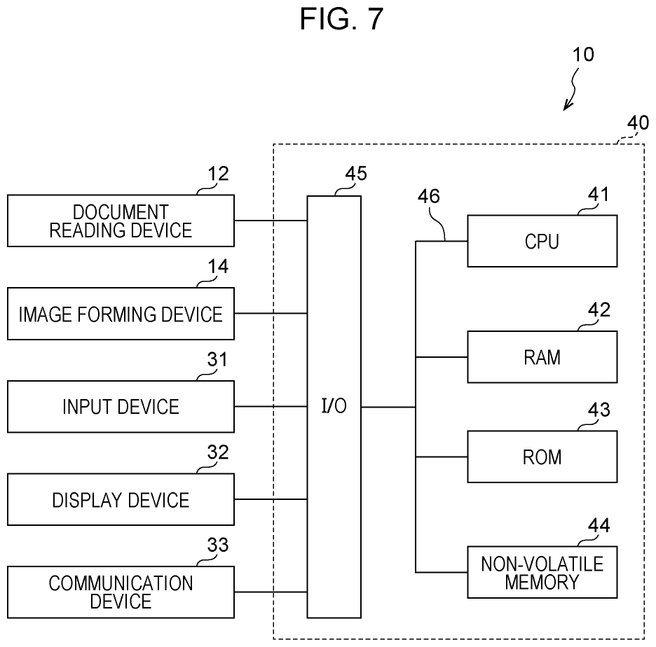

Next, the configuration of the substantial part of an electrical system of the image processing apparatus 10 will be described with reference to FIG. 7. The image processing apparatus 10 is implemented using, for example, a computer 40.

In the computer 40, a central processing unit (CPU) 41, a random access memory (RAM) 42, a read only memory (ROM) 43, a non-volatile memory 44, and an input/output interface (I/O) 45 are connected to each other via a bus 46.

The CPU 41 is an example of a processor configured to perform processing of the functional units of the image processing apparatus 10 illustrated in FIG. 4. The RAM 42 is an example of a storage medium to be used as a temporary work area for the CPU 41. The ROM 43 is an example of a storage medium that stores an information processing program to be executed by the CPU 41. The non-volatile memory 44 is an example of a storage medium configured such that information stored therein is maintained even if power supply to the non-volatile memory 44 is shut off. Examples of the non-volatile memory 44 include a semiconductor memory and a hard disk. The non-volatile memory 44 is not necessarily incorporated in the computer 40, and may be, for example, a storage medium attachable to the computer 40 in a removable manner, such as a memory card.

The I/O 45 is connected to, for example, the document reading device 12, the image forming device 14, an input device 31, a display device 32, and a communication device 33.

The document reading device 12 and the image forming device 14 are devices that perform operations as described above. The input device 31 is a device that notifies the CPU 41 of an instruction from the user and a user ID of the user in response to receipt of the instruction and the user ID. Examples of the input device 31 include a touch panel constituting the operation panel 15, and the reader device 17. The display device 32 is a device that visually displays information processed by the CPU 41. Examples of the display device 32 include a display constituting the operation panel 15. The communication device 33 is connected to the communication line 2 and has a communication protocol for communicating with the terminals 4. The devices connectable to the I/O 45 are not limited to the devices illustrated in FIG. 7. The I/O 45 may be connected to a device necessary for implementing a function in accordance with the functions of the image processing apparatus 10.

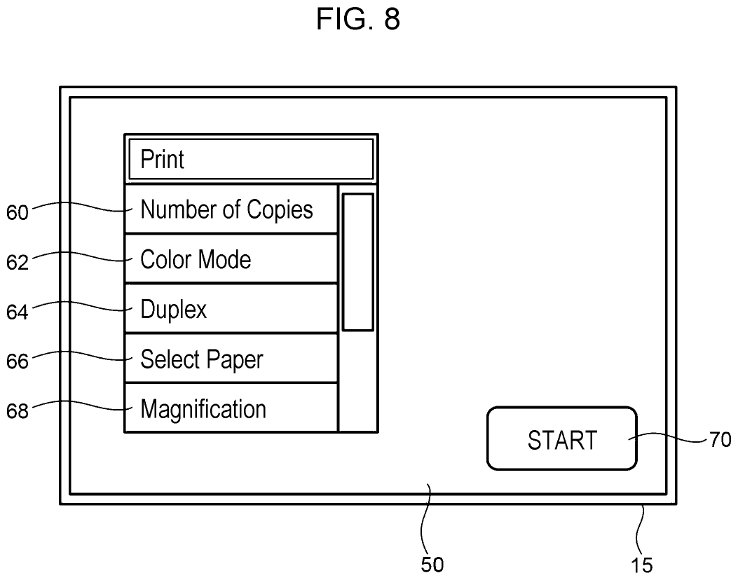

Next, a predetermined selection operation for selecting an object, which is performed by the image processing apparatus 10 according to the present exemplary embodiment, will be described in detail. An object selection operation of the image processing apparatus 10 makes it less likely that a user will unintentionally select an object than an operation of selecting an object by keeping the user's finger hovering over the object for a predetermined amount of time or an operation of selecting an object by bringing the user's finger close to or away from the object. Specifically, in the operation of selecting an object by keeping the user's finger hovering over the object for a predetermined amount of time, the user's motion to bring their finger close to the screen for a contact operation may be determined to be a motion to keep the finger hovering over the object for a predetermined amount of time, and consequently the object may erroneously be operated. In the operation of selecting an object by moving the user's finger close to or away from the object, the object may erroneously be operated in response to a motion to bring the user's finger close to the screen for a contact operation. Accordingly, the image processing apparatus 10 according to the present exemplary embodiment is configured to accept a contact operation on an object displayed on a screen with the user's finger serving as a target in response to the user's finger coming into contact with the screen, and to accept a contactless operation on the object with the user's finger in response to detection of the user's finger at a position away from the screen, the contactless operation involving movement of a detected position (the operation position 6) of the user's finger in the screen. One example of the selection operation for selecting an object in a contactless manner according to the present exemplary embodiment is an operation of moving a detected position of a target, which is detected above an area that displays the object in a screen, away from above the area by a predetermined distance or more and then bringing the target back to above the area within a predetermined time. The object selection operation will be described hereinafter using a print screen 50 illustrated in FIG. 8 as an example.

FIG. 8 is a front view of the print screen 50 on the operation panel 15 as viewed from the front.

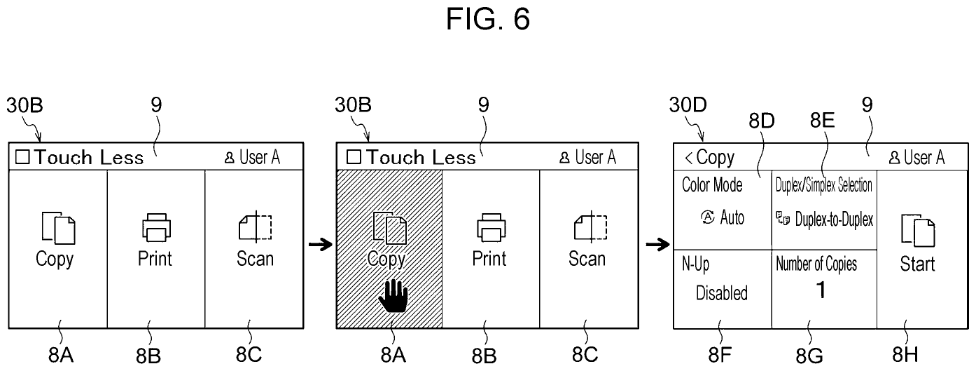

The print screen 50 illustrated in FIG. 8 displays, as example objects, a number-of-copies button 60, a color mode button 62, a duplex (or double-sided) printing button 64, a paper selection button 66, a magnification button 68, and a start button 70. The print screen 50 illustrated in FIG. 8 is an example of a screen displayed in response to selection of the “Print” button 8B on the home screen 30B illustrated in FIG. 6.

The number-of-copies button 60 is a button having a function of selecting the number of copies of data to be printed (also referred to as a print target). The number-of-copies button 60 is selected, thereby making a transition to a screen (not illustrated) for setting the number of copies to be printed.

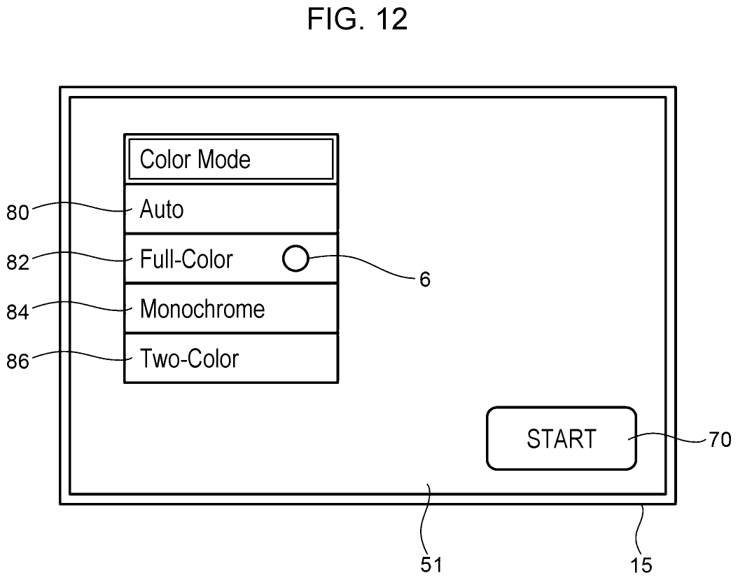

The color mode button 62 is a button having a function of selecting a color mode of the print target. The color mode button 62 is selected, thereby making a transition to a print screen 51 as illustrated in FIG. 12 for setting the color mode. The print screen 51 displays, as example objects, an auto button 80, a full-color button 82, a monochrome button 84, a two-color button 86, and the start button 70. The auto button 80 is a button having a function of causing the CPU 41 or the like to determine whether to print the print target in color or monochrome. The full-color button 82 is a button having a function of printing the print target in full color. The monochrome button 84 is a button having a function of printing the print target in monochrome. The two-color button 86 is a button having a function of printing the print target in two colors.

The duplex printing button 64 is a button having a function of selecting duplex printing of the print target. The duplex printing button 64 is selected, thereby making a transition to a screen (not illustrated) for setting the orientation of duplex printing.

The paper selection button 66 is a button having a function of selecting the paper to print the print target on. The paper selection button 66 is selected, thereby making a transition to a screen (not illustrated) for setting the paper to print on (paper size).

The magnification button 68 is a button having a function of selecting the print magnification of the print target. The magnification button 68 is selected, thereby making a transition to a screen (not illustrated) for setting the print magnification of the print target.

The duplex printing button 64, the paper selection button 66, and the magnification button 68 are objects having functions related to printing of the print target. Accordingly, these buttons are arranged adjacent to each other.

The start button 70 is a button having a function of executing processing to print the print target. The start button 70 is used to print the print target in accordance with information that is set (or selected) by various buttons related to printing.

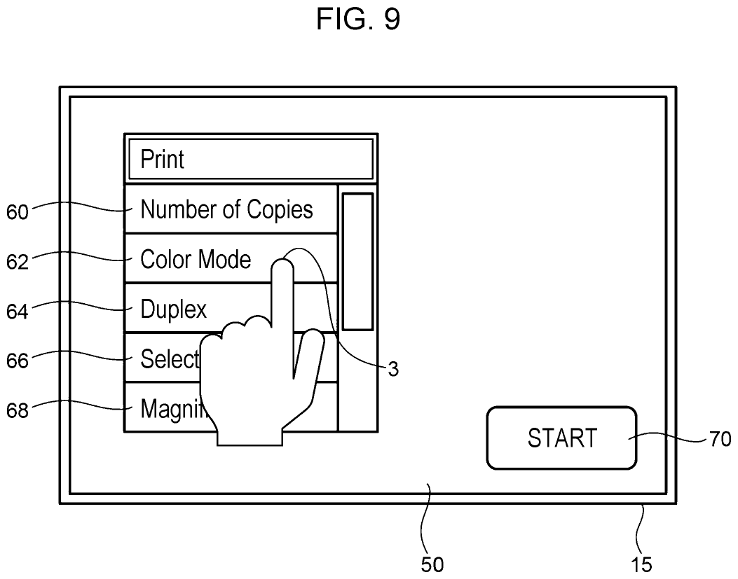

Next, an example of a contactless operation of the image processing apparatus 10 according to the present exemplary embodiment will be described with reference to FIGS. 9 to 19.

In the present exemplary embodiment, as an example, as illustrated in FIG. 9, when an object in the print screen 50 is to be operated with the user's finger 3 in a contactless manner, an operation assigned to the object is executed if it is determined that the user's finger 3, which is detected above an area that displays the object in the print screen 50, has moved away from above the area by a predetermined distance or more and then returned to above the area within a predetermined time (an example of a third threshold time). Specifically, if it is determined that the detected position of the user's finger 3, which is detected above an area that displays the object, has moved away from above the area by a predetermined distance or more within a first threshold time that is determined in advance and then returned to above the area within a second threshold time that is determined in advance, the operation assigned to the object is executed. The sum of the first threshold time and the second threshold time corresponds to the third threshold time.

Specifically, as illustrated in FIG. 9, for example, when the user's finger 3 is held over the color mode button 62 in the print screen 50, the CPU 41 detects the user's finger 3 above the color mode button 62. That is, the CPU 41 determines that the operation position 6 is within the area of the color mode button 62 on the print screen 50.

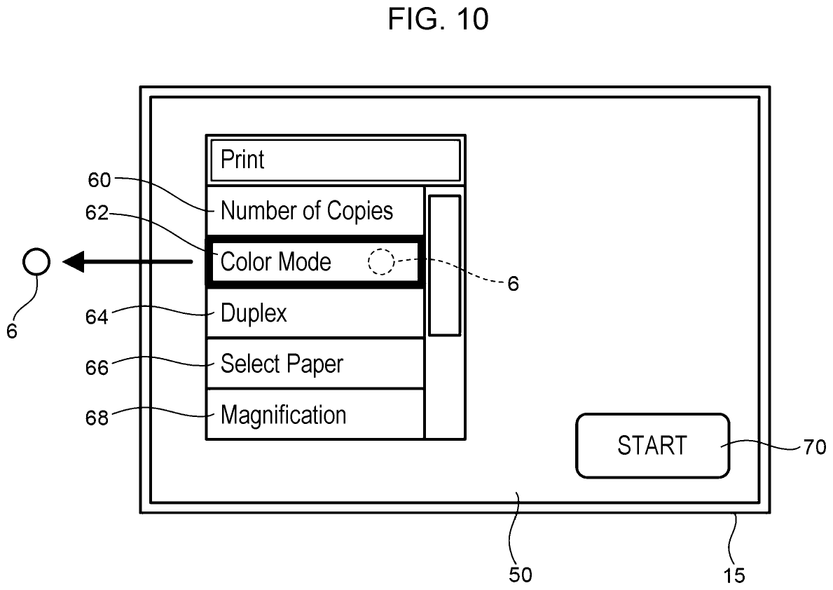

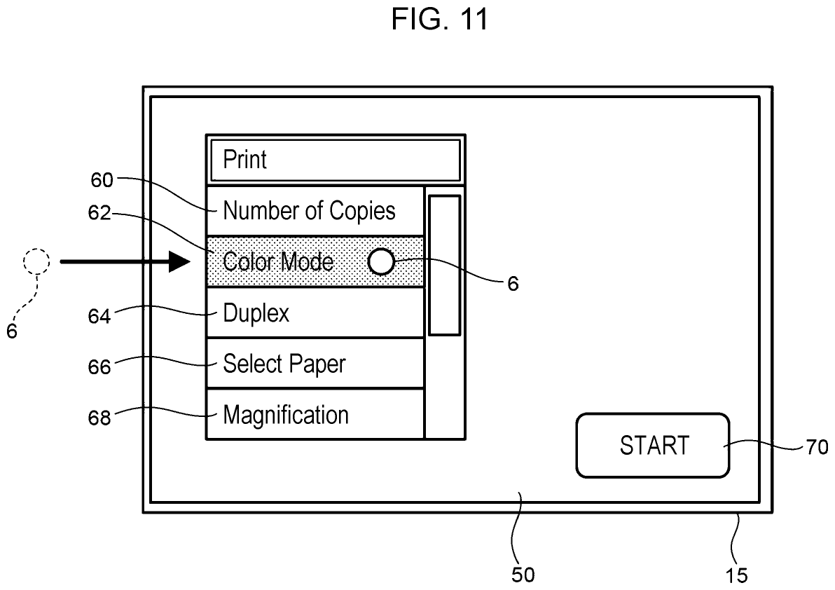

Then, if the CPU 41 determines that the operation position 6 has moved away from above the area of the color mode button 62 by a predetermined first distance Th1 or more in a manner as illustrated in FIG. 10 and then returned to above the area of the color mode button 62 in a manner as illustrated in FIG. 11 within a predetermined time, the CPU 41 executes an operation assigned to the color mode button 62. That is, when the user's finger 3 returns to above the area of the color mode button 62 after leaving from above the area of the color mode button 62, the CPU 41 confirms the selection operation on the color mode button 62, and executes the operation assigned to the color mode button 62, namely, an operation of making a transition from the print screen 50 to the print screen 51. That is, the selection operation for selecting an object according to the present exemplary embodiment is an operation of moving the user's finger 3 away from above an intended object by the first distance Th1 or more and then bringing the user's finger 3 back to above or around the intended object.

The CPU 41 may determine that the user's finger 3 is away from the intended object by the first distance Th1 or more if the user's finger 3 has moved out of the detection range from the edge of the print screen 50. Specifically, the CPU 41 may determine that the user's finger 3 is away from the intended object by the first distance Th1 or more if the operation position 6 has moved on the print screen 50 along the surface of the print screen 50 (to the left in FIG. 10) and has exited the detection range from the edge of the print screen 50.

Further, if the operation position 6 has moved away from above the area of the color mode button 62 by the first distance Th1 or more and then, as illustrated in FIG. 11, moved to above the area of the color mode button 62 along the surface of the print screen 50, the CPU 41 determines that the user's finger 3 has returned to above the area of the color mode button 62. That is, even when the user's finger 3 corresponding to the operation position 6 does not return to a position having the same coordinates as first coordinates (for example, (x1, y1)) above the area of an object, the CPU 41 determines that the object is selected if the user's finger 3 returns to above the area of the object including the first coordinates.

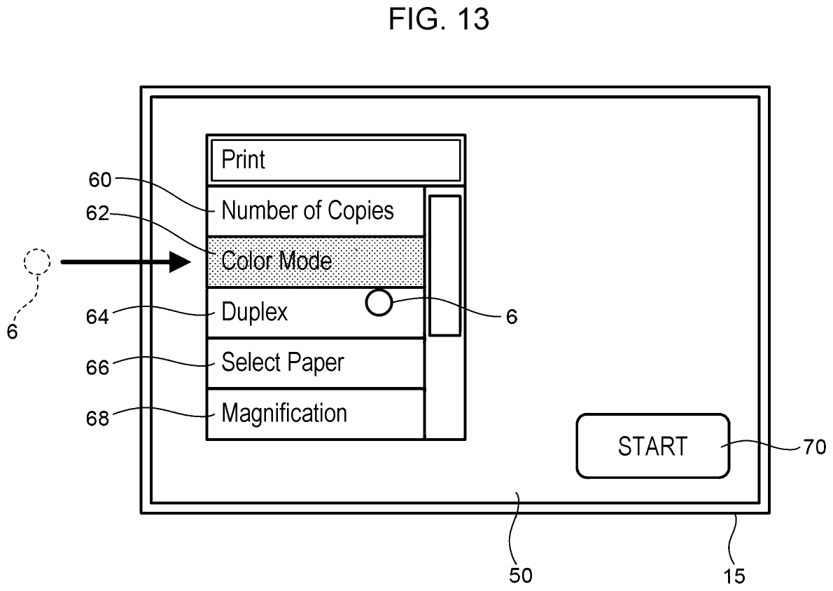

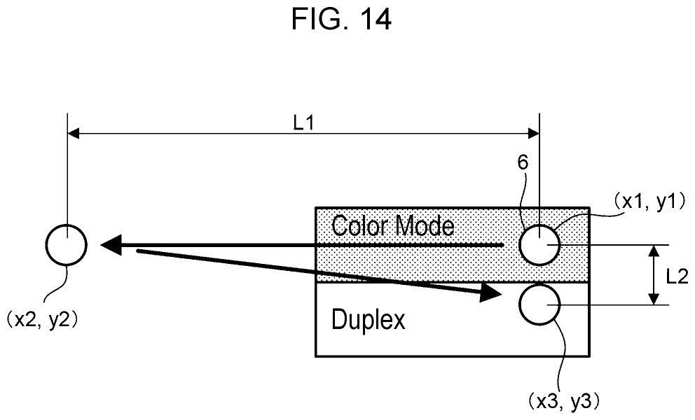

Further, as illustrated in FIGS. 13 and 14, if the CPU 41 determines that the user's finger 3 has moved away from the detected position (the first coordinates) of the user's finger 3 in the print screen 50 by a predetermined first distance Th1 or more and then returned to a position within a predetermined second distance Th2 from the detected position (the first coordinates) within a predetermined time, the CPU 41 may execute the operation assigned to the object. Specifically, as illustrated in FIG. 14, the operation position 6 moves from a position defined by the first coordinates (x1, y1) in the area of the color mode button 62 to a position defined by second coordinates (x2, y2) away from the first coordinates by the first distance Th1 or more, and then moves (returns) from the position defined by the second coordinates to a position defined by third coordinates (x3, y3). The position defined by the third coordinates is included in the area of the duplex printing button 64 and is within the predetermined second distance Th2 from the position defined by the first coordinates. In this case, the CPU 41 may confirm the selection operation of the color mode button 62 and execute the operation assigned to the color mode button 62, namely, an operation of making a transition from the print screen 50 to the print screen 51. In the selection of one of adjacent objects, the contactless operation may make it difficult for the user's finger 3 to return to above the desired object. The setting described above allows the user to select the desired object by returning the user's finger 3 to above an area within the second distance Th2 from the position defined by the first coordinates, even if the user's finger 3 is difficult to return to above the area of the desired object.

The first distance Th1 described above refers to a threshold (first threshold) for a distance L1 from the position defined by the first coordinates (x1, y1) to the position defined by the second coordinates (x2, y2). The second distance Th2 refers to a threshold (second threshold) for a distance L2 from the position defined by the first coordinates (x1, y1) to the position defined by the third coordinates (x3, y3).

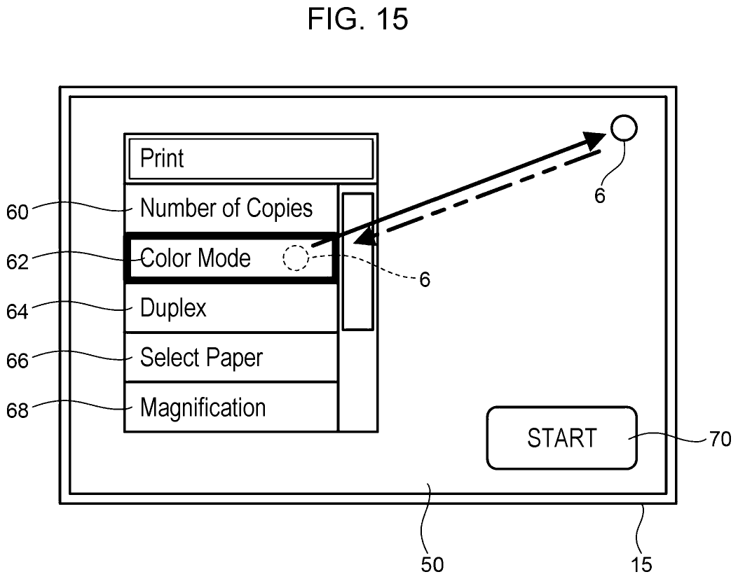

In FIG. 10, the user's finger 3 moves out of the detection range from the edge of the print screen 50. In contrast, as illustrated in FIG. 15, the user's finger 3 may move within the print screen 50. Even in this case, if the operation position 6 is away from above the area of the color mode button 62 by the first distance Th1 or more and then returns to above the area of the color mode button 62 within a predetermined time, the CPU 41 executes the operation assigned to the color mode button 62.

In the present exemplary embodiment, furthermore, when the user's finger 3 detected above the area of an object in the print screen 50 moves away from above the area by the first distance Th1 or more, the CPU 41 may change the display of the object. Specifically, in the example illustrated in FIG. 10, when the operation position 6 is away from above the color mode button 62, the CPU 41 sets an object temporary mode (temporary selection) and makes the outer frame (border line) of the color mode button 62 thicker. The present disclosure is not limited to this configuration. For example, the text of the color mode button 62 may be made thicker, the line type of the outer frame of the color mode button 62 may be changed, or the color of the color mode button 62 may be changed.

In the present exemplary embodiment, furthermore, the CPU 41 may change the display of the object when the selection operation of the object is confirmed. Specifically, in the example illustrated in FIG. 11, when the operation position 6 returns to above the intended color mode button 62, the CPU 41 sets an object operation mode (confirmed selection) and changes the color of the color mode button 62. In one example, the display of the object is changed between the temporary mode and the operation mode to allow the user to visually recognize whether the object is in the temporary mode or the operation mode.

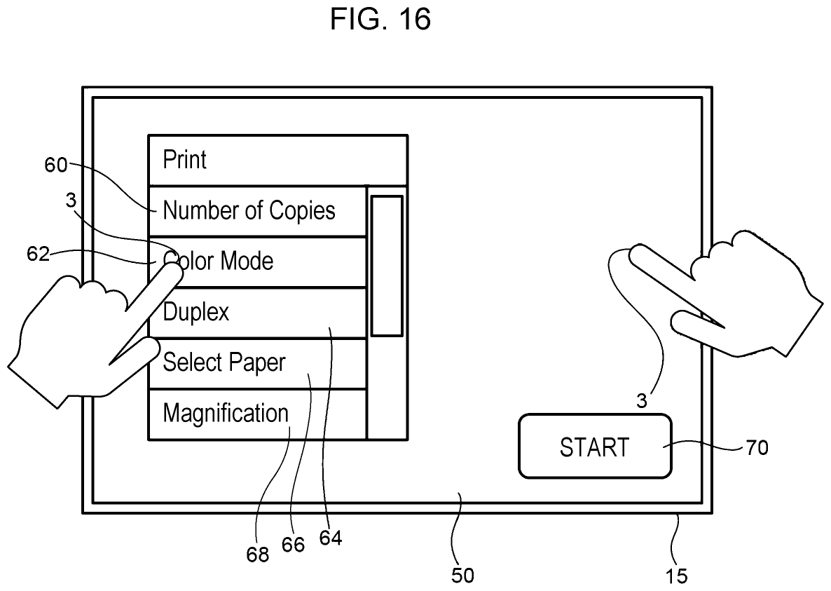

While the object selection operation described above can be performed with one hand, the object selection operation may be performed with both hands. The selection operation performed with both hands will be described with reference to FIGS. 16 to 19.

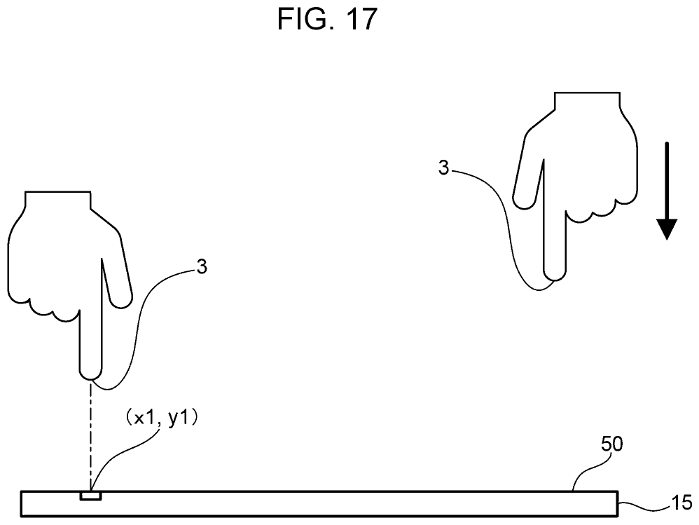

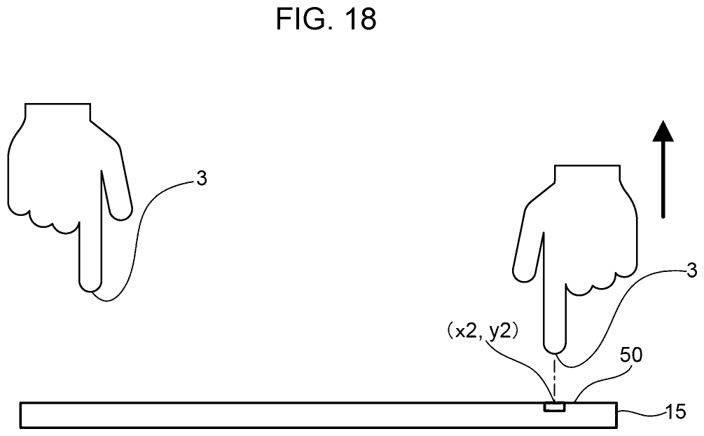

As illustrated in FIG. 16, a finger 3 of the user's one hand detected above the area of the intended object (in FIG. 16, the color mode button 62) in the screen remains unmoving (see FIG. 17), and a finger 3 of the user's other hand is detected at a position away from above the area of the intended object by the first distance Th1 or more (see FIG. 18). In this case, the CPU 41 may determine that the user's finger 3 is away from above the area of the intended object by the first distance Th1 or more. Specifically, as illustrated in FIG. 17, the CPU 41 detects the finger 3 of the user's one hand above the area of the intended object in the print screen 50. After that, as illustrated in FIG. 18, when the finger 3 of the user's other hand approaches the print screen 50 without the movement of the finger 3 of the user's one hand, the CPU 41 detects the finger 3 of the user's other hand. At this time, the finger 3 of the user's other hand, which is located at a position away from the position of the finger 3 of the user's one hand defined by the first coordinates (x1, y1) by the first distance Th1 or more, is detected. The position of the finger 3 of the user's other hand is defined by the second coordinates (x2, y2).

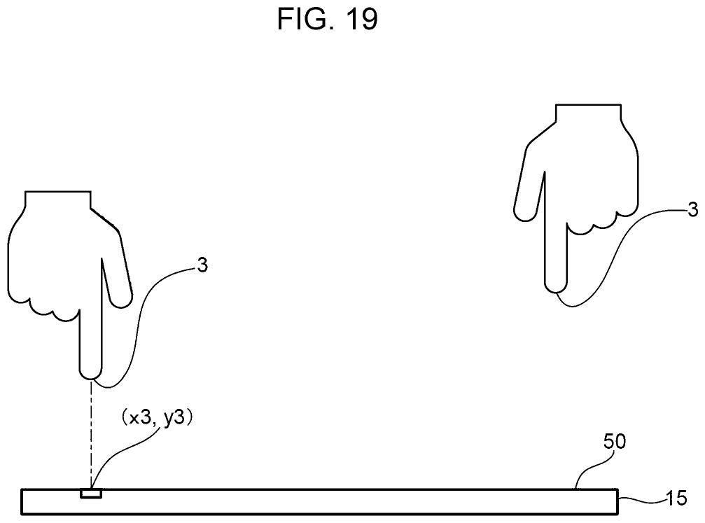

Then, when the finger 3 of the user's other hand detected in the screen moves out of the detection range and the finger 3 of the user's one hand above the intended object is detected, the CPU 41 may execute the operation assigned to the object. Specifically, as illustrated in FIG. 19, when the finger 3 of the user's other hand moves away from the print screen 50 and is out of the detection range of the operation panel 15, the finger 3 of the user's one hand is detected. The currently detected position of the finger 3 of the user's one hand is defined by the third coordinates (x3, y3). The third coordinates (x3, y3) are the same as the first coordinates (x1, y1) when the finger 3 of the user's one hand remains unmoving.

When the user's finger 3 comes into contact with the screen that displays an object, the CPU 41 accepts a contact operation on the object with the user's finger 3. For example, in the example illustrated in FIG. 9, when the user's finger 3 comes into contact with the color mode button 62 displayed on the print screen 50, the CPU 41 accepts the contact operation and determines that the color mode button 62 has been selected. After the user's finger 3 comes into contact with a portion other than the area in which the object is displayed on the print screen 50 to switch to a contact operation, the object may be selected by the contact operation with the user's finger 3. During the acceptance of the contact operation with the user's finger 3, the CPU 41 may stop accepting any contactless operation. The period for accepting a contact operation with the user's finger 3 may end after a predetermined period elapses from when the user's finger 3 leaves from the screen, or may end in response to execution of a logout operation (logout process) for clearing the authentication of the user.

Further, when the user's finger 3 comes into contact with the screen during the temporary selection (temporary mode) of the object, the CPU 41 may cancel the temporary selection of the object. Specifically, as illustrated in FIG. 10, when the user's finger 3 comes into contact with the print screen 50 during the temporary selection of the color mode button 62, the CPU 41 may cancel the temporary selection of the color mode button 62, that is, the outer frame of the color mode button 62 may return to the original state before the temporary selection (see FIG. 9).

During the temporary selection of the object, the CPU 41 may stop accepting a contact operation. Specifically, even if the user's finger 3 comes into contact with the print screen 50 when the object is being temporarily selected through a contactless operation, the CPU 41 may stop accepting a contact operation with the user's finger 3.

Further, when the user's finger 3 comes into contact with the screen during processing of an operation assigned to an object through a contactless operation, the CPU 41 may stop the processing for the object. Specifically, if a contact operation on the print screen 50 is detected during a printing process executed in response to selection of the start button 70 through a contactless operation, the CPU 41 may stop the printing process.

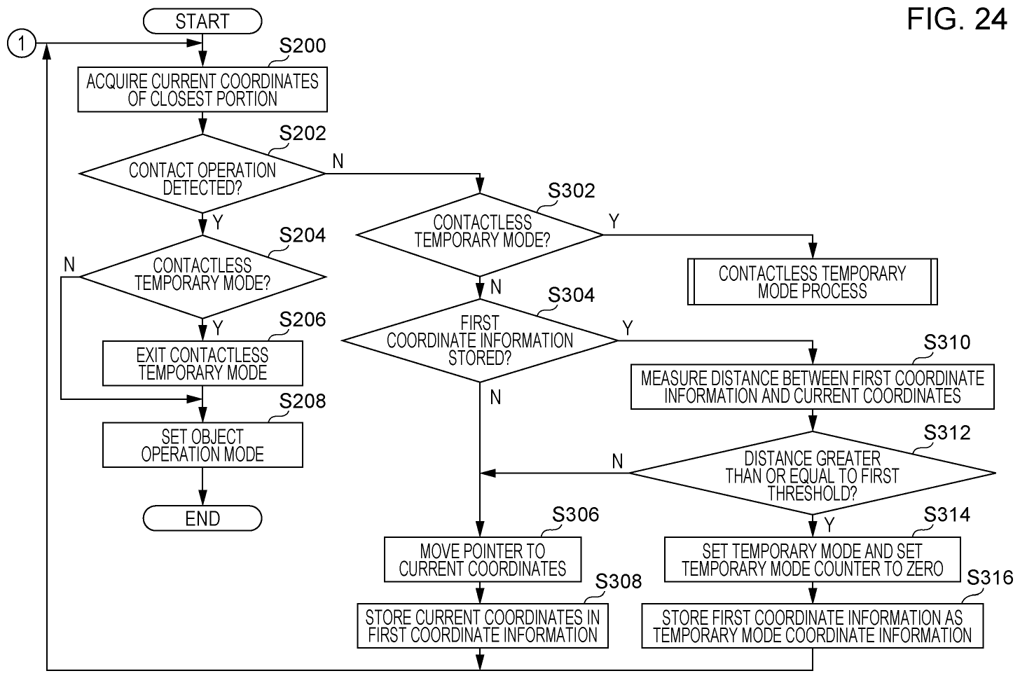

Next, the operation of the image processing apparatus 10 according to the present exemplary embodiment will be described with reference to FIG. 24.

FIG. 24 is a flowchart illustrating an example of a process flow of an information processing program according to the present exemplary embodiment.

First, in response to an instruction to execute a contactless input through the operation panel 15, the CPU 41 activates the information processing program and executes the steps described below.

Referring to FIG. 24, in step S200, the CPU 41 acquires the current coordinates of the portion closest to the screen. In other words, the CPU 41 acquires the current finger coordinates of the user's finger 3, which is the target with which to perform a contactless operation. After that, the process proceeds to step S202.

In step S202, the CPU 41 determines whether the user's finger 3 has come into contact with the print screen 50 on the operation panel 15. That is, the CPU 41 determines whether a contact operation with the user's finger 3 is detected. If a contact operation with the user's finger 3 is detected, the process proceeds to step S204. If a contact operation with the user's finger 3 is not detected, the process proceeds to step S302.

In step S204, the CPU 41 determines whether an object is temporarily selected through a contactless operation, that is, whether a contactless temporary mode is set. If the contactless temporary mode is set, the process proceeds to step S206. If the contactless temporary mode is not set, the process proceeds to step S208.

In step S206, the CPU 41 stops the temporary selection of the object temporarily selected through the contactless operation. That is, the CPU 41 exits the contactless temporary mode. After that, the process proceeds to step S208.

In step S208, the CPU 41 sets the object operation mode through a contact operation. Thereafter, the CPU 41 selects the object through a contact operation to perform processing associated with the object.

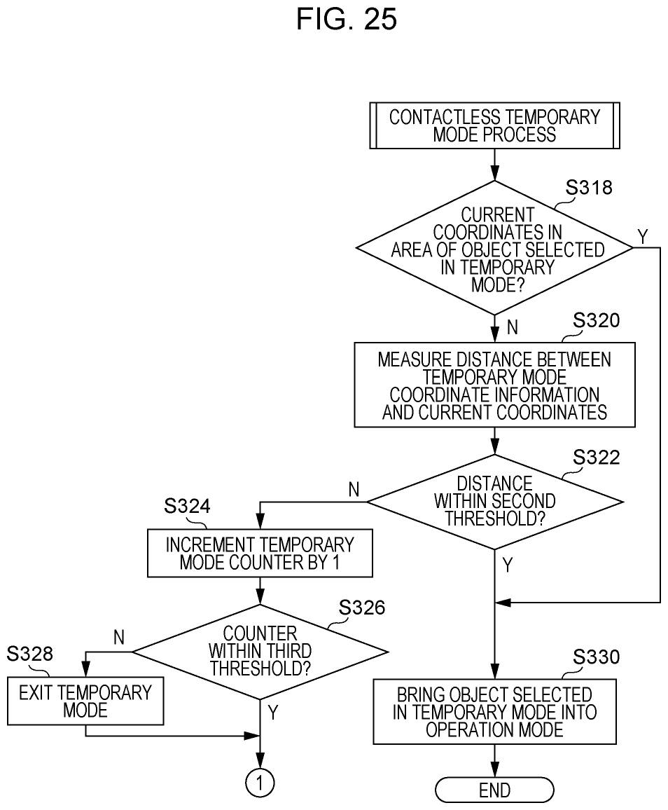

In step S302, the CPU 41 selects whether the selection of the object is performed in the temporary mode. If the selection of the object is not performed in the temporary mode, the process proceeds to step S304. If the selection of the object is performed in the temporary mode, the CPU 41 executes a contactless temporary mode process illustrated in FIG. 25. The contactless temporary mode process will be described below.

In step S304, the CPU 41 determines whether first coordinate information is stored. If the first coordinate information is not stored, the process proceeds to step S306. If the first coordinate information is stored, the process proceeds to step S310.

In step S306, the CPU 41 moves the pointer to the current finger coordinates. Then, the process proceeds to step S308.

In step S308, the CPU 41 stores the current finger coordinates (for example, the first coordinates (x1, y1)) in the first coordinate information. After that, the process proceeds to step S200.

In step S310, the CPU 41 measures the distance L1 between the first coordinate information (the first coordinates (x1, y1)) and the current finger coordinates (for example, the second coordinates (x2, y2)).

In step S312, the CPU 41 determines whether the distance L1 is greater than or equal to a first threshold (the first distance Th1). If the distance L1 is greater than or equal to the first threshold, the process proceeds to step S314. If the distance L1 is less than the first threshold, the process proceeds to step S306.

In step S314, the CPU 41 brings the object into the temporary mode. Further, the CPU 41 sets a temporary mode counter to zero. After that, the process proceeds to step S316.

In step S316, the CPU 41 stores the first coordinate information (the first coordinates (x1, y1)) as temporary mode coordinate information. After that, the process proceeds to step S200.

Next, an example of the contactless temporary mode process in the flowchart illustrated in FIG. 24 will be described with reference to FIG. 25.

In step S318, the CPU 41 determines whether the current finger coordinates (for example, the third coordinates (x3, y3)) are in the area of an object selected in the temporary mode. If it is determined that the current finger coordinates are not in the area of the object selected in the temporary mode, the process proceeds to step S320. If it is determined that the current finger coordinates are in the area of the object selected in the temporary mode, the process proceeds to step S330.

In step S320, the CPU 41 measures the distance L2 between the temporary mode coordinate information (the first coordinates (x1, y1)) and the current finger coordinates (the third coordinates (x3, y3)). Then, the process proceeds to step S322.

In step S322, the CPU 41 determines whether the distance L2 is within a second threshold (the second length Th2). If the distance L2 is within the second threshold, the process proceeds to step S330. If the distance L2 exceeds the second threshold, the process proceeds to step S324.

In step S324, the CPU 41 increments the temporary mode counter by 1. Then, the process proceeds to step S326.

In step S326, the CPU 41 determines whether the temporary mode counter is within a third threshold. The third threshold is a predetermined threshold number of times. If the temporary mode counter is within the third threshold, the process proceeds to step S200. If the temporary mode counter exceeds the third threshold, the process proceeds to step S328.

In step S328, the CPU 41 exits the temporary mode of the object. Then, the process proceeds to step S200.

In step S330, the CPU 41 brings the object selected in the temporary mode into the operation mode. Thereafter, the CPU 41 performs processing associated with the selected object. As an example, when the object is the color mode button 62, the CPU 41 makes a transition from the print screen 50 to the print screen 51.

In the present exemplary embodiment, the CPU 41 accepts a contact operation on an object displayed on a screen with the user's finger 3 in response to the user's finger 3 coming into contact with the screen, and accepts a contactless operation on the object in response to detection of the user's finger 3 at a position away from the screen, the contactless operation involving movement of a detected position of the user's finger in the screen. Specifically, in response to determining that a selection operation is performed in which the user's finger 3 moves away from above an intended object by the first distance Th1 or more and then moves back to above or around the intended object, the CPU 41 executes a process associated with the intended object. Accordingly, the present exemplary embodiment may make it less likely that the user will unintentionally select an object than, for example, a case of accepting a contactless operation on the object in response to keeping the user's finger 3 hovering over the object for a predetermined amount of time. The present exemplary embodiment may also make it less likely that the user will unintentionally select an object than, for example, a case of accepting a contactless operation on the object in response to a motion to bring the user's finger 3 close to or away from the object. In other words, in the present exemplary embodiment, the occurrence of erroneous operations on an object may be prevented or reduced.

In the present exemplary embodiment, the CPU 41 may determine that the user's finger 3 is away from the object by the first distance Th1 or more if the user's finger 3 has moved out of the detection range from the edge of the print screen 50. In this case, the user can more easily perform an operation on the object than in a case where, for example, the selection operation is disabled when the user's finger 3 moves out of the detection range.

In the present exemplary embodiment, if the CPU 41 determines that the user's finger 3 has moved away from the detected position of the user's finger 3 in the print screen 50 by the first distance Th1 or more and then returned to a position within the second distance Th2 from the detected position within a predetermined time, the CPU 41 may execute the operation assigned to the object. In this case, the operation is executed on the object even if which the user's finger 3, which is the target with which to perform a contactless operation, has returned to a position deviating from a position above the area of the object.

In the present exemplary embodiment, when the user's finger 3 detected above the area of an object in the print screen 50 is away from above the area by the first distance Th1 or more, the CPU 41 may change the display of the object or change the color of the object. This may allow the user to visually recognize whether the object is in the temporary mode (temporary selection).

In the present exemplary embodiment, when a finger 3 of the user's one hand detected above the area of an object in the print screen 50 remains unmoving and a finger 3 of the user's other hand is detected at a position away from above the area of the object by the first distance Th1 or more, the CPU 41 may determine that the user's finger 3 is away from above the area of the object by the first distance Th1 or more. In this case, the user can more easily execute an operation on the object than in a case where the operation is disabled when the finger 3 of the user's one hand remains unmoving along the surface of the print screen 50 and the finger 3 of the user's other hand is detected at a position away from above the area of the object by the first distance Th1 or more.

In the present exemplary embodiment, when the finger 3 of the user's other hand detected in the print screen 50 moves out of the detection range and the finger 3 of the user's one hand above the area of the object is detected, the CPU 41 may execute the operation assigned to the object. In this case, the operation on the object is simplified, as compared with a case where the operation assigned to the object is executed in response to the movement of the finger 3 of the user's other hand to above the area of the object.

In the present exemplary embodiment, the CPU 41 may stop accepting any contactless operation during the acceptance of the contact operation with the user's finger 3. In this case, the occurrence of erroneous operations on an object may be prevented or reduced, as compared with a case where both a contact operation and a contactless operation with the user's finger 3 are simultaneously accepted.

In the present exemplary embodiment, the CPU 41 may end the period for accepting a contact operation with the user's finger 3, after a predetermined period elapses from when the user's finger 3 leaves from the screen. In this case, the occurrence of erroneous operations on an object may be prevented or reduced, as compared with a case where the period for accepting a contact operation ends immediately after the user's finger 3 has left from the screen.

In the present exemplary embodiment, the CPU 41 may accept a login operation for authenticating the user, and end the period for accepting a contact operation with the user's finger 3, in response to execution of a logout operation for clearing the authentication of the user. In this case, the user executes the logout operation, thereby starting a contactless operation without waiting for the end of the period for accepting a contact operation.

In the present exemplary embodiment, when the user's finger 3 comes into contact with the screen during the temporary selection of an object through a contactless operation, the CPU 41 may cancel the temporary selection of the object. In this case, the occurrence of erroneous operations on an object may be prevented or reduced, as compared with a case where the temporary selection of an object is not canceled even if the user's finger 3 comes into contact with the screen during the temporary selection of the object.

In the present exemplary embodiment, the CPU 41 may stop accepting any contact operation during the temporary selection of an object through a contactless operation. In this case, the occurrence of erroneous operations on an object may be prevented or reduced, as compared with a case where a contact operation is accepted during the temporary selection of the object.

In the present exemplary embodiment, when the user's finger 3 comes into contact with the screen during the processing of an operation assigned to an object through a contactless operation, the CPU 41 may stop the processing for the object. In this case, if the object is erroneously operated, the processing for the object is stopped halfway.

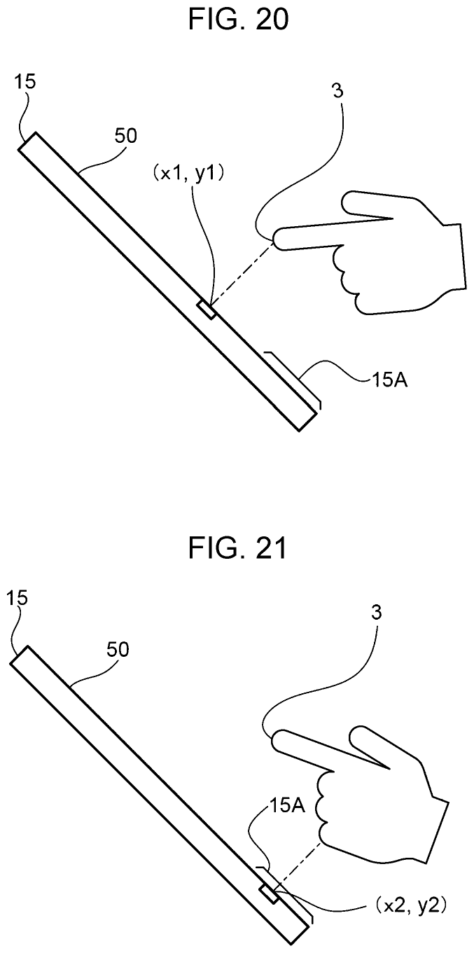

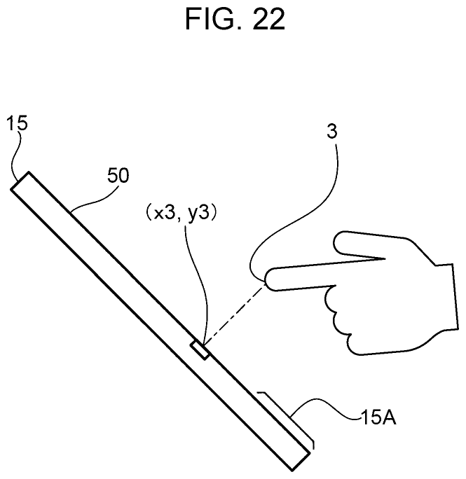

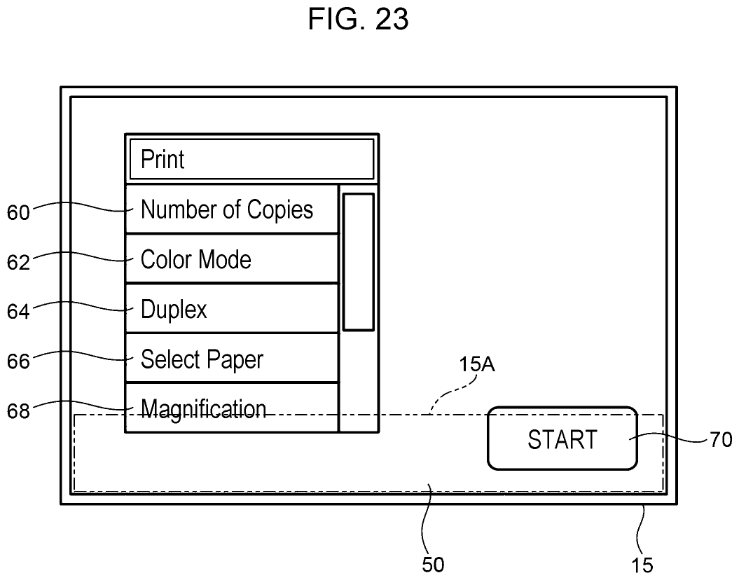

In addition, as illustrated in FIGS. 20 to 23, if a portion (or finger) of the user's hand different from the finger 3 is detected above an area designated in advance in the screen, the CPU 41 may make the detection invalid. Specifically, when the operation panel 15 is arranged obliquely, as illustrated in FIG. 20, in response to the user bringing the finger 3 close to the print screen 50, the CPU 41 acquires the finger coordinates (x1, y1) as those of the operation position 6. Then, as illustrated in FIG. 21, when the user tilts their hand and a portion other than the finger 3 becomes closer to the print screen 50, the CPU 41 acquires the finger coordinates (x2, y2). Then, as illustrated in FIG. 22, when the user returns the tilted hand to the original state, the finger 3 becomes closer to the print screen 50 again, and the CPU 41 acquires the finger coordinates (x3, y3). In the present exemplary embodiment, as illustrated in FIG. 23, a lower portion of the print screen 50 is represented as a detection invalid area 15A. The detection invalid area 15A is set such that a detection of the finger coordinates (x2, y2) to bring the object into the temporary mode is made invalid even if the detection takes place in the detection invalid area 15A. That is, in response to acquisition of the finger coordinates (x1, y1) followed by the finger coordinates (x2, y2), if the finger coordinates (x2, y2) are in the detection invalid area 15A, the CPU 41 makes the detection of the finger coordinates (x2, y2) invalid. In the example illustrated in FIGS. 20 to 23, the object is not brought into the temporary mode. The detection invalid area 15A provided in the print screen 50 may prevent or reduce the occurrence of erroneous operations on an object, as compared with a case where, for example, detection of another target is valid in the entire area of the print screen 50. For example, even when a portion of the user's body comes into contact with the detection invalid area 15A of the print screen 50 while the user is operating the print screen 50 with their finger 3, the selection operation of the object is not enabled, resulting in a reduction in operations on an object not intended by the user.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

An image processing apparatus has been described as an example of an information processing apparatus according to some exemplary embodiments. Exemplary embodiments may provide a program for causing a computer to execute the functions of the information processing apparatus. Exemplary embodiments may provide a non-transitory computer-readable storage medium storing such a program.

In addition, the configuration of an information processing apparatus described in the exemplary embodiments described above is an example and may be changed depending on the situation without departing from the scope of the present disclosure.

Additionally, a process flow of a program described in the exemplary embodiments described above is also an example, and any unnecessary step may be deleted, a new step may be added, or the processing order may be changed without departing from the scope of the present disclosure.

In the exemplary embodiments described above, a program is executed to implement processing according to an exemplary embodiment by a software configuration using a computer, by way of example but not limitation. The exemplary embodiments may be implemented by, for example, a hardware configuration or a combination of a hardware configuration and a software configuration.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))
   An information processing system comprising:
   a processor configured to:
      accept a contact operation with a target for an object displayed on a screen in response to the target coming into contact with the screen; and
      accept a contactless operation with the target for the object in response to detection of the target at a position away from the screen, the contactless operation including movement of a detected position of the target in the screen.
(((2)))
   The information processing system according to (((1))), wherein the processor is configured to stop accepting the contactless operation during acceptance of a contact operation with the target.
(((3)))
   The information processing system according to (((2))), wherein a period for accepting a contact operation with the target ends after a predetermined period elapses from when the target leaves from the screen.
(((4)))
   The information processing system according to (((2))), wherein the processor is configured to accept a login operation for authenticating a user, and a period for accepting a contact operation with the target ends in response to execution of a logout operation for clearing authentication of the user.
(((5)))
   The information processing system according to any one of (((1))) to (((4))), wherein the processor is configured to, when the object in the screen is to be operated with the target in a contactless manner, temporarily select the object displayed in an area of the screen and change display of the object or change a color of the object in response to determining that a detected position of the target detected above the area is away from above the area by a predetermined distance or more within a predetermined time.
(((6)))
   The information processing system according to (((5))), wherein the processor is configured to, in response to the target coming into contact with the screen during temporary selection of the object, cancel the temporary selection of the object.
(((7)))
   The information processing system according to (((5))), wherein the processor is configured to stop accepting the contact operation during temporary selection of the object.
(((8)))
   The information processing system according to any one of (((5))) to (((7))), wherein the processor is configured to execute an operation assigned to the object displayed in the area in response to determining that the detected position of the target detected above the area has moved away from above the area by the predetermined distance or more within a first threshold time and then returned to above the area within a predetermined second threshold time, the first threshold time being the predetermined time.
(((9)))
   The information processing system according to (((8))), wherein the processor is configured to execute the operation assigned to the object displayed in the area in response to determining that the target has moved away from the detected position of the target detected above the area by a first distance or more and then returned to a position within a predetermined second distance from the detected position of the target within a predetermined third threshold time, the first distance being the predetermined distance.
(((10)))
   The information processing system according to any one of (((5))) to (((9))), wherein the processor is configured to, in response to the target coming into contact with the screen during processing of an operation assigned to the object through a contactless operation with the target, stop the processing for the object.
(((11)))
   An information processing program for causing a computer to:
   accept a contact operation with a target for an object displayed on a screen in response to the target coming into contact with the screen; and
   accept a contactless operation with the target for the object in response to detection of the target at a position away from the screen, the contactless operation including movement of a detected position of the target in the screen.

What is claimed is:

1. An information processing system comprising:
a processor configured to:
accept a contact operation with a target for an object displayed on a screen in response to the target coming into contact with the screen; and
accept a contactless operation with the target for the object in response to detection of the target at a position away from the screen, the contactless operation including movement of a detected position of the target in the screen.

2. The information processing system according to claim 1, wherein
the processor is configured to stop accepting the contactless operation during acceptance of a contact operation with the target.

3. The information processing system according to claim 2, wherein
a period for accepting a contact operation with the target ends after a predetermined period elapses from when the target leaves from the screen.

4. The information processing system according to claim 2, wherein
the processor is configured to accept a login operation for authenticating a user, and
a period for accepting a contact operation with the target ends in response to execution of a logout operation for clearing authentication of the user.

5. The information processing system according to claim 1, wherein
the processor is configured to, when the object in the screen is to be operated with the target in a contactless manner, temporarily select the object displayed in an area of the screen and change display of the object or change a color of the object in response to determining that a detected position of the target detected above the area is away from above the area by a predetermined distance or more within a predetermined time.

6. The information processing system according to claim 5, wherein
the processor is configured to, in response to the target coming into contact with the screen during temporary selection of the object, cancel the temporary selection of the object.

7. The information processing system according to claim 5, wherein
the processor is configured to stop accepting the contact operation during temporary selection of the object.

8. The information processing system according to claim 5, wherein
the processor is configured to execute an operation assigned to the object displayed in the area in response to determining that the detected position of the target detected above the area has moved away from above the area by the predetermined distance or more within a first threshold time and then returned to above the area within a predetermined second threshold time, the first threshold time being the predetermined time.

9. The information processing system according to claim 8, wherein
the processor is configured to execute the operation assigned to the object displayed in the area in response to determining that the target has moved away from the detected position of the target detected above the area by a first distance or more and then returned to a position within a predetermined second distance from the detected position of the target within a predetermined third threshold time, the first distance being the predetermined distance.

10. The information processing system according to claim 5, wherein
the processor is configured to, in response to the target coming into contact with the screen during processing of an operation assigned to the object through a contactless operation with the target, stop the processing for the object.

11. A non-transitory computer readable medium storing a program causing a computer to execute a process for information processing, the process comprising:
accepting a contact operation with a target for an object displayed on a screen in response to the target coming into contact with the screen; and
accepting a contactless operation with the target for the object in response to detection of the target at a position away from the screen, the contactless operation including movement of a detected position of the target in the screen.

12. An information processing method comprising:
accepting a contact operation with a target for an object displayed on a screen in response to the target coming into contact with the screen; and
accepting a contactless operation with the target for the object in response to detection of the target at a position away from the screen, the contactless operation including movement of a detected position of the target in the screen.
